(19) United States
(12) Patent Application Publication
(10) Pub. No.: US 2017/0243204 A1
(43) Pub. Date: Aug. 24, 2017

(54) METHOD AND SYSTEM FOR SECURE OBJECT TRANSFER

(71) Applicant: Private Giant, Orlando, FL (US)

(72) Inventors: Shaun Murphy, Orlando, FL (US); Charles Murphy, Sarasota, FL (US); Richard Johnson, Briarcliff Manor, NY (US)

(73) Assignee: Private Giant, Orlando, FL (US)

(21) Appl. No.: 15/429,003

(22) Filed: Feb. 9, 2017

Related U.S. Application Data
(60) Provisional application No. 62/297,738, filed on Feb. 19, 2016.

(51) Int. Cl. G06Q 20/38; H04L 29/08; G06Q 30/06; H04L 12/58

(52) U.S. Cl. CPC G06Q 20/3829; H04L 51/08; H04L 67/06; G06Q 30/0633; G06Q 2220/10

(57) ABSTRACT

A messaging and content sharing platform that allows for securely transferring an object. During operation, the system may receive the object from a sending device operated by a user, wherein the object is a message or other content. The system may receive data indicating one or more restrictions set by the user associated with the object. The system may receive a request from a receiving device to obtain the object. The system may then determine that one or more restrictions associated with the request to obtain the object are satisfied, and send a portion of the object to the receiving device.

### RELATED APPLICATION

This application claims the benefit of U.S. Provisional Application No. 62/297,738 Attorney Docket No. PRIV15-1002PSP, entitled “METHOD AND SYSTEM FOR CONVERSATIONAL COMMERCE,” by inventors Shaun Murphy, Charles Murphy, and Richard Johnson, filed 19 Feb. 2016, the disclosure of which is incorporated by reference herein.

The subject matter of this application is related to the subject matter in a provisional application by the same inventors as the instant application and filed on 24 Jun. 2015, Attorney Docket Number PRIV15-1001PSP, entitled “METHOD AND SYSTEM FOR CONTROLLING ACCESS TO ENCRYPTED DATA,” having Ser. No. 62/183,855, the disclosure of which is incorporated by reference herein.

The subject matter of this application is related to the subject matter in a co-pending non-provisional application by the same inventors as the instant application and filed on 18 Jun. 2014, Attorney Docket Number PRIV13-1000CON, entitled “CONFIDENTIAL MESSAGE EXCHANGE USING BENIGN, CONTEXT-AWARE COVER MESSAGE GENERATION,” having Ser. No. 14/308,612, the disclosure of which is incorporated by reference herein.

The subject matter of this application is related to the subject matter in a co-pending non-provisional application by the same inventors as the instant application and filed on 18 Dec. 2014, Attorney Docket Number PRIV13-1001CON, entitled “METHOD AND SYSTEM FOR AUTOMATIC GENERATION OF CONTEXT-AWARE COVER MESSAGE,” having Ser. No. 14/576,010, the disclosure of which is incorporated by reference herein.

The subject matter of this application is related to the subject matter in a co-pending non-provisional application by the same inventors as the instant application and filed on 2 Oct. 2015, Attorney Docket Number PRIV15-1001US, entitled “METHOD AND SYSTEM FOR SENDER-CONTROLLED MESSAGING AND CONTENT SHARING,” having Ser. No. 14/874,346, the disclosure of which is incorporated by reference herein.

The subject matter of this application is related to the subject matter in issued U.S. Pat. No. 8,782,409 by the same inventors as the instant application and filed on 4 Jun. 2012, Attorney Docket Number PRIV13-1000US, entitled “CONFIDENTIAL MESSAGE EXCHANGE USING BENIGN, CONTEXT-AWARE COVER MESSAGE GENERATION,” having Ser. No. 13/488,391, the disclosure of which is incorporated by reference herein.

The subject matter of this application is related to the subject matter in issued U.S. Pat. No. 8,918,896 by the same inventors as the instant application and filed on 30 May 2013, Attorney Docket Number PRIV13-1001US, entitled “METHOD AND SYSTEM FOR AUTOMATIC GENERATION OF CONTEXT-AWARE COVER MESSAGE,” having Ser. No. 13/906,039, the disclosure of which is incorporated by reference herein.

### BACKGROUND

Field

This disclosure is generally related to secure object transfer. More specifically, this disclosure is related to a messaging, content sharing, and object transfer platform with transaction security and other features.

Related Art

As an increasing number of users come online, they seek to purchase digital content and physical goods online. Existing mobile and electronic commerce typically requires a presentation layer, such as a website or a mobile application that has a shopping cart and a checkout process. The shopping cart and checkout process is not convenient for users, and many users leave their shopping carts without completing the purchase of items. This adds much friction to the distribution of digital and physical goods and also leaves the purchasing parties vulnerable to malicious attackers as the retailer may not secure payment, shipping, or other personally identifiable information.

### SUMMARY

One embodiment provides a system for securely transferring an object. During operation, the system may receive the object from a sending device operated by a user, wherein the object is a message or other content. The system may receive data indicating one or more restrictions set by the user associated with the object. The system may receive a request from a receiving device to obtain the object. The system may then determine that one or more restrictions associated with the request to obtain the object are satisfied, and send a portion of the object to the receiving device.

In some embodiments, the system may receive user communication indicating that an attachment or a file located on a server is a product. The system may determine a subscription and current storage usage associated with an account associated with the user. The system may determine that the account lacks sufficient storage capacity. The system may inform the user that account lacks sufficient storage capacity, and receive a user request to increase the storage capacity.

In some embodiments, the system may receive a user request to upgrade to allow transferring the object or other objects stored at a server to one or more receiving devices.

In some embodiments, the system may initiate a conversation and generate a new data structure framework in at least one of device memory and storage for the conversation, and allocate and initialize at least one of the device memory and storage to hold content to be transferred.

In some embodiments, the system may receive at least one of data indicating user input from a second user scanning a Quick Response (QR) code of an item, data indicating the second user taking a picture of a the item, and data indicating the second user sending a message to a merchant's account that the second user would like to purchase the item. The system may provide to the second user at least a product token, and receive a payment token and a shipping label from the second user. The system may then provide the second user with a cryptographically secure receipt indicating a purchase of the item, and receive data indicating that the item has been sent to the second user.

In some embodiments, the system may receive data from the sending device indicating that the receiving device may display a thumbnail preview but may not download a full version or unlock the full version until payment is received.

In some embodiments, a rule is one of disallowing the receiving device from taking a screenshot of the object, disallowing the receiving device from printing the object, disallowing the receiving device from downloading the object, requiring that the receiving device delete an object after taking a screenshot, and requiring that the receiving device delete an object after the user views the object.

In some embodiments, the system may also receive a request from a second device, wherein the second device has been forwarded the message and/or content. The system may receive a request to download a full version or unlock the full version from the second device. The system may determine that the second device has been forwarded the message and/or content from the recipient device, and fulfill the request to download the full version or unlock the full version from the second device.

In some embodiments, the system may also receive data indicating that a particular user sends at least one of money, content, and communication to an email address or Short Message Service (SMS) number. The system may complete a transaction when another party to the transaction signs up to receive the at least one of money, content, and communication.

In some embodiments, a permission indicates whether the receiving device is allowed to perform one of stash the message and/or content, remove a participant from the message header indicating parties that receive the message and associated replies, take a screenshot that includes the message and/or content, select text from the message and/or content, print the message and/or content, and download the message and/or content to external storage.

In some embodiments, the object is encrypted with a symmetric key and the symmetric key is encrypted with a public key of the receiving device; and sending the portion of the object further includes encrypting the object and sending a portion of the encrypted object to the receiving device.

In some embodiments, the one or more restrictions include that the content may not be downloaded without payment.

In some embodiments, the system may divide a content file into at least two portions. The system may send at least one portion of the content file to a server that does not store the other portion. The system may receive a query from the receiving device with a unique identifier associated with the one portion of the content file, and the system may provide the content file to the receiving device.

In some embodiments, receiving a request from a receiving device to obtain the object further includes receiving a request from the receiving device for message and/or attachment data, and determining that one or more restrictions associated with the request to obtain the object are satisfied further includes determining that a purchase price associated with the object has been paid.

### BRIEF DESCRIPTION OF THE FIGURES

FIG. 1 illustrates an exemplary network environment that facilitates a messaging and content sharing platform with conversational commerce capabilities in accordance with an embodiment.

FIG. 2 presents a flowchart illustrating an overview of an exemplary process for sending a message and/or product content to a recipient in a purchase transaction in accordance with an embodiment.

FIG. 3 presents a flowchart illustrating an exemplary process for physical product purchase in accordance with an embodiment.

FIG. 4 presents a flowchart illustrating an exemplary method for sending a message and/or product content to a recipient in a purchase transaction in accordance with an embodiment.

FIG. 5 presents a flowchart illustrating an exemplary method for a purchasing party to purchase and obtain content in accordance with an embodiment.

FIG. 6 illustrates an exemplary client apparatus that facilitates a messaging and content sharing platform with conversational commerce in accordance with an embodiment.

FIG. 7 illustrates an exemplary computer system that facilitates a messaging and content sharing platform with conversational commerce in accordance with an embodiment.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of insecure and inefficient transfer of content and objects by providing a conversational approach to transfers where two or more parties may securely send messages, digital content, and data associated with physical objects. The parties may also send other information required for transferring physical and electronic objects.

With embodiments of the present invention, two or more parties may freely engage in a conversation (via chat, email, Short Message Service (SMS), or other social media) about digital or physical products, and the purchase and transfer of the products. The seller may set restrictions on the objects to be transferred, such as restricting download until payment is received or restricting the ability of the receiving party to forward a message content. The seller may transmit conditions for removing restrictions on digital content and decrypting the full version of digital products. For physical products, the parties may also send associated information such as secure shipping information/labels to a retailer so that the retailer need not maintain any data associated with the parties.

### Improvements Over Existing Systems

The disclosed invention represents an improvement over existing digital content transfer and mobile and electronic commerce technology that requires a presentation layer (commonly a website or mobile app) that has a shopping cart, checkout process, etc. Such existing technology unnecessarily complicates and slows down the distribution of digital and physical goods. Existing technology also may cause the parties to be vulnerable to malicious attackers as the retailer may not secure payment, shipping, or other personally identifiable information.

Improvements over existing systems include the additional security and efficiency associated with transferring the content being purchased. With existing systems such as eBay, there is no efficiency and security for the transfer of goods. If a buyer purchases products on eBay and there is no delivery, the buyer's only recourse is to dispute the transaction. With embodiments of the present invention, the seller may release (e.g., download or decrypt) the product upon receiving payment (or the system may automatically release (e.g., download or decrypt) the product upon receiving payment). For example, a photographer may send unencrypted low-quality thumbnail images to a potential buyer with encrypted full resolution photos, and the buyer may click on a purchase control and perform the purchase transaction. The system may release encryption keys to the buyer and the buyer may decrypt full resolution photos. This is a secure and efficient process. The system is more efficient than existing technology since there is no need to wait to obtain full resolution photos. There is greater security and efficiency since the system may automatically deliver information for decrypting encrypted data to the receiving device and the receiving device may automatically decrypt the encrypted content.

Improvements over existing systems may include a uniform integrated look and feel. In some embodiments, the system can integrate website layouts, or particular merchant designs, from multiple merchants' websites or databases. This provides a uniform look and feel across different merchants for users that are using the communication platform, while providing the users access to multiple merchants and a secure method for performing transactions.

Improvements over existing systems may also include the system's ability to automatically apply rules set up by a merchant (and/or other administrator). For example, in some embodiments, the system may apply rules set up by a merchant to automatically interact with users to complete a sales transaction. These rules may, for example, define automatic responses to user inquiries or automatic responses to user action (such as taking a screenshot by a recipient), and may also define other actions for securing data on potential customers' mobile devices. The system may automatically apply the rules at the server or on the receiving user's mobile device.

### Exemplary Network Environment

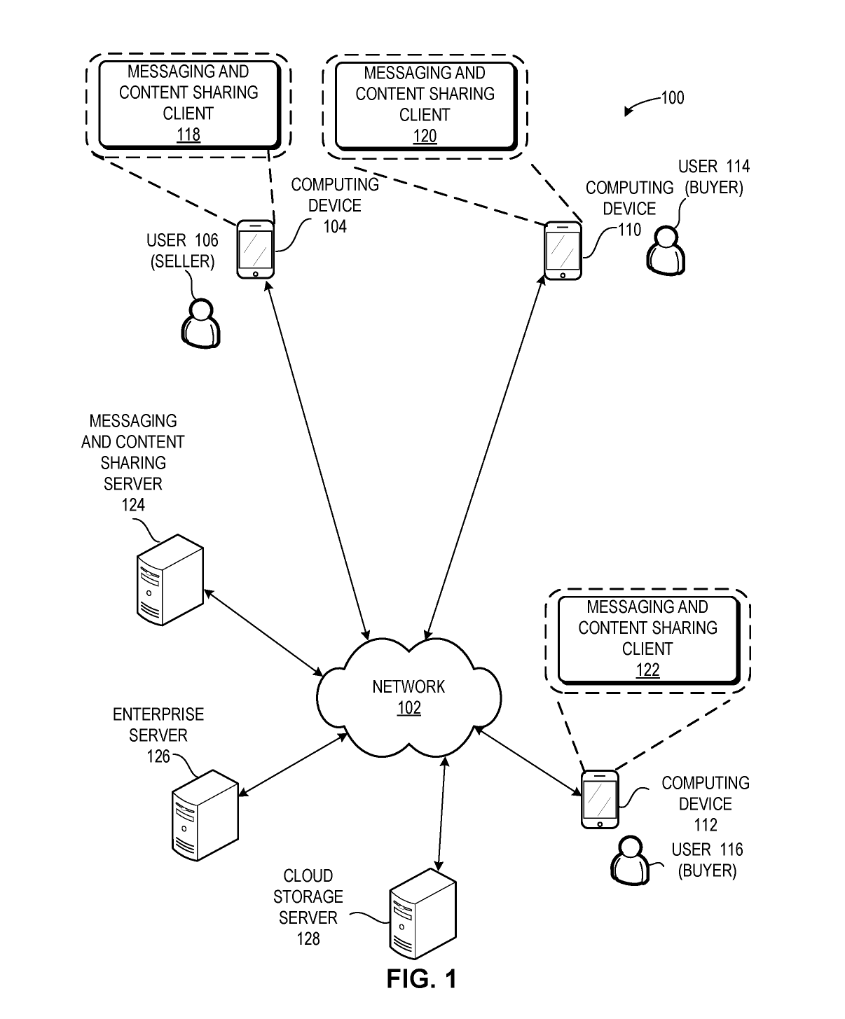

FIG. 1 illustrates an exemplary network environment 100 that facilitates a messaging and content sharing platform with conversational commerce capabilities in accordance with an embodiment. Network environment 100 can include a computer network 102, which can include any wired or wireless network that interfaces various computing devices to each other, such as a computer network implemented via one or more technologies (e.g., Bluetooth, Wi-Fi, cellular, Ethernet, fiber-optic, etc.). In some embodiments, network 102 includes the Internet.

Network environment 100 can also include a computing device 104, which a user 106 may use to communicate a message, transfer content, and/or conduct a sales transaction with another computing device, such as a computing device 110 or a computing device 112. A user 114 may operate computing device 110 and a user 116 may operate computing device 112. User 106 may use a messaging and content sharing client 118 installed on computing device 104 to send messages or other content to the other users. The message or content can be text, voice, and/or video, images, text documents, or any other type of data. Client software 118 allows a user to send messages, message attachments, files, and/or other content, and/or perform sales transactions for digital content and/or physical items. Computing device 110 and computing device 112 also have installed messaging and content sharing clients 120, 122 respectively. Although FIG. 1 depicts computing device 104 as a smartphone, computing device 104 can be also be a personal computer or any device that user 106 can use to send messages or share file/content with user 112.

A messaging and content sharing server 124 can store and execute server software, and may store content such as files or attachments from messages that a user shares with others or transfers to others. The system may split up a file so that malicious attackers have greater difficulty finding and reassembling the separate parts of the encrypted file. Server 124 can store small portions of encrypted files and/or large portions of the encrypted files. The system may also send a large portion of an encrypted file to an enterprise hardware device, such as an enterprise server 126, for storage. Further, the system may store a large portion of the encrypted file using cloud storage services, such as a cloud storage server 128. Note that generally the system can split apart objects (encrypted or not), and store a portion of the object in one location and the remainder of the object in any number of other locations, the details of which are further disclosed in U.S. Provisional Application No. 62/183,855 and U.S. patent application Ser. No. 14/874,346. Objects may include, but are not limited to, pictures, videos, documents, text messages, emails, and other digital items.

### Main Process Flows

This disclosure covers three main process flows:
1.) The unsolicited sending of digital currency to another person
2.) Sender transmits digital content with a set price, and recipient chooses to buy or not
3.) Recipient views a physical product on a website, brick and mortar store, etc. and uses the platform to initiate the purchase

The first flow is very basic, e.g., user A sends digital currency to user B. Digital currency may include, but is not limited to: credit/debit card information, digital wallet payment tokens (apple pay, android pay, etc.), and/or decentralized digital currency.

Digital currency transactions on the system may use various mechanisms including, but not limited to, input of credit or debit card details into a form, a third party generated digital payment token, and an entry in a decentralized wallet using a system-protected set of cryptographic keys. The transactions may be processed by a third party payment processor. Digital currency may be optionally stored in a system-protected digital wallet for offline storage, subsequent payment processing, sharing among users of the system, and synchronization between devices.

Overview of Flow for Sending Message and/or Product Content

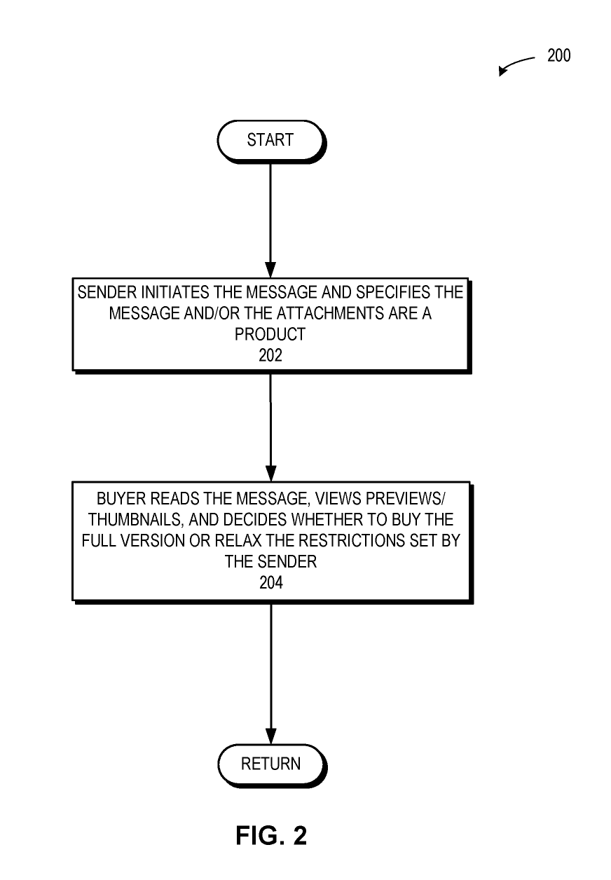

FIG. 2 presents a flowchart 200 illustrating an overview of an exemplary process for sending a message and/or product content to a recipient in a purchase transaction in accordance with an embodiment. The second flow may include two sequences. The first sequence is the sender initiates the message and specifies the message and/or the attachments are a product (operation 202). The attachments, for example, may be grouped such that a set are all part of a single package price or they may be individually priced. In some embodiments, the product may also be previously uploaded to a server and the message may refer to the product. The buyer is then able to read the message, view previews/thumbnails, and decide whether to buy the full version or remove the restrictions set by the sender (operation 204).

The disclosed features may operate with each other and may also interact independently with the system. For example, a user may be able to send a file with a thumbnail to a recipient with the restriction that the recipient can preview the thumbnail but not decrypt the full version (and/or download the full version to the recipient's system). The system does not provide the recipient with the key to decrypt the full version until the recipient pays the sender a set amount of money. The recipient may be allowed to forward the message even if the recipient does not pay for the message. The user that receives the forwarded message may also purchase the digital content.

Note that the recipient need not be an existing user on the system. In some embodiments, the selling party (or purchasing party) can send money and/or content and/or communication to an email address or SMS number associated with a broker, and the purchase transaction only completes when the other party to the transaction (e.g., intended recipient) signs up to view the transaction.

### Physical Product Purchase Flow

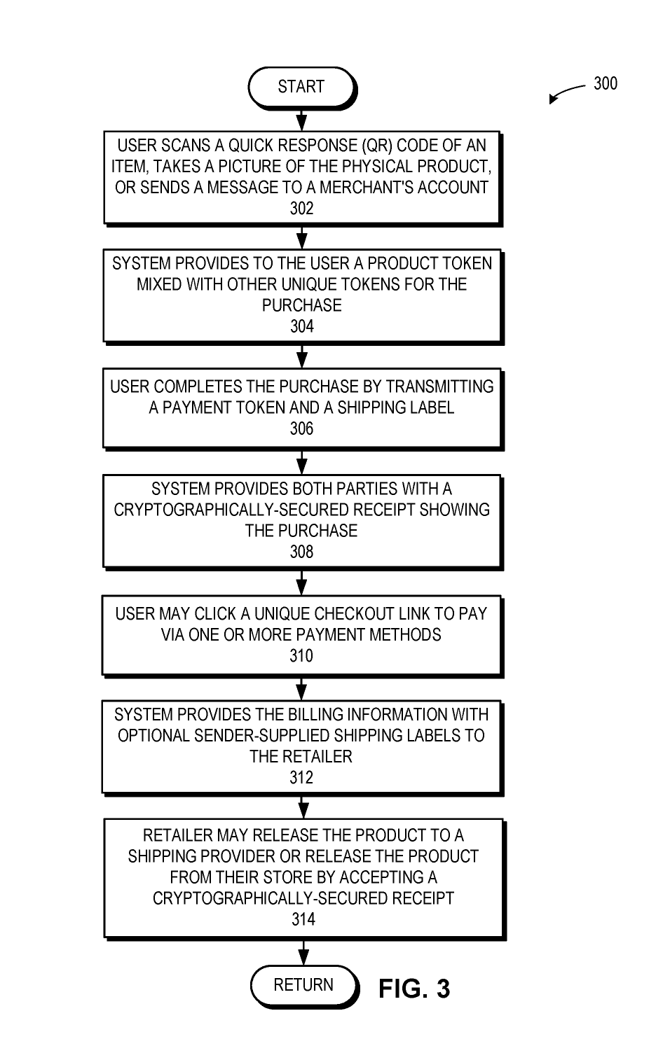

FIG. 3 presents a flowchart 300 illustrating an exemplary process for physical product purchase in accordance with an embodiment. The third flow is a physical product purchase flow involving a consumer user scanning a Quick Response (QR) code of an item, taking a picture of the item (e.g., a physical product), or sending a message to a merchant's account that they would like to purchase the item (operation 302). The automated system may provide to the user a product token mixed with other unique tokens for the purchase (operation 304). The user may then complete the purchase by transmitting a payment token and a shipping label to the system (operation 306). The system may provide both parties with a cryptographically-secured receipt showing the purchase (operation 308). For an online retailer, the user may click a unique checkout link to pay via one or more payment methods (operation 310). The system may provide the billing information with optional sender-supplied shipping labels to the retailer (operation 312). The retailer may then release the product to a shipping provider or release the product from their store by accepting a cryptographically-secured receipt (operation 314).

### Controlling Access to Attachments or Contents of Communication

Embodiments of the present invention may also include methods and systems for controlling access to the attachments or contents of a communication, including but not limited to the ability of the sender to control copying, printing, downloading, and/or forwarding of the attachment, message, or content. The sender's computing device may have messaging software installed that allows the sender to specify restrictions on the ability of the receiving party (e.g., the buyer) to use the attachment or contents of the communication. The receiving party/buyer may pay the sender to remove one or more restrictions.

A user selling content may control the recipient's use of messages or other content using permissions and rules. A permission associated with an object, such as a message and/or content, indicates an operation that a receiving device may perform on the object. The user may set one or more permissions to control the operations that the recipients can perform with the messages/content. For example, the sending user may set permissions to allow or prevent recipients from forwarding a message, locally download an attachment, and add/remove a participant in a group message. The sending user may also set permissions to allow or prevent recipients from taking a screenshot, printing, and/or archiving a message or content. The user can set default permissions that apply globally or per contact. The user can also set fine-grained permissions, such as permissions that apply per user and/or per attachment. Furthermore, the user may change the permissions at any time.

Some embodiments may also include the ability to transfer large files online and/or in the background. The message recipient may receive a link to a large file stored on a server in the cloud or the recipient's messaging software may automatically download a large file attachment when the user clicks on an icon or other visual depiction granting access to and/or representing the large file. These features may or may not be used together with a secure system, and may or may not be used as part of the commerce being conducted.

The buyer may also initiate and/or complete a purchase transaction using various types of communication software. For example, the buyer may make purchases within communication software that includes, but is not limited to, instant messaging software, e-mail, or other types of texting (e.g., Short Message Service (SMS)) or social media program. The buyer can receive a link to the product or receive the product itself as included with the message.

### Security Measures

The buyer may execute a purchase transaction within a highly secure system, or without additional security. The security measures can include encrypting the product, encrypting a link to the product, or encrypting a description of the product. Security measures can also include encrypting information that includes, but is not limited to, the payment information, product price negotiations, and associated communications between the two parties to the transaction. Security measures can also include restrictions on access to functions, which includes but is not limited to allowing the buyer to copy, download, print, view, or take a screenshot, or other forms of restrictions on the product being purchased. After the buyer completes the purchase transaction, the system may remove one or more restrictions. For example, the buyer may pay to remove the restriction on viewing the product, or the buyer may pay to remove all restrictions on the product. When the system removes the restrictions, the buyer can use the product accordingly, such as unlimited copying or printing of the product. In some implementations, the system can add a restriction that the buyer is allowed to perform an operation on the product a predetermined number of times. For example, the buyer may be allowed to view the product for a predetermined number of hours or download a product for a predetermined number of times.

There are a number of ways that the buyer may purchase products. In some implementations, the buyer may have messaging software installed on his computing device that includes a purchase control (e.g., a purchase key or button) which simplifies the process of purchasing the product. The buyer can simply operate the purchase control in order to purchase the product. In other implementations, the buyer may follow a link to a website to complete the transaction. For example, a photographer may send digital products including picture files or movie files to a recipient with a communication message, and the recipient can click a link or push a button to purchase the pictures. The buyer can purchase the pictures from the photographer using the same communication software through which the buyer receives the digital products. For example, the digital products may be attached to an e-mail or sent directly via instant messaging, or the buyer may receive a link to content stored on a server in the cloud. The buyer may purchase the pictures by clicking the link or pushing the button. The buyer may have stored information on his computing device that includes bank account or credit card information for completing the transaction.

Some embodiments may include a secure web browser within the messaging software. The secure web browser allows the buyer to securely view and purchase products. From within the messaging software, the buyer can launch the secure web browser to visit websites and make purchases. The buyer may use the secure web browser to follow a link in a message received from the selling party to complete a purchase transaction.

The security may include privacy measures that do not reveal to other parties that the buyer is communicating and/or performing the purchase transaction with another party. A selling party may optionally send product purchase information using a cover message that allows the recipient to purchase the product without any third-party realizing that such a transaction is occurring. The cover message can be a benign, contextually appropriate message or any other type of message that does not reveal information about the sending party or the receiving party, and does not reveal that there is a product available for purchase, and/or does not reveal that there is a product being purchased. The cover message can be a contextually appropriate message in that the system uses some personal contextual information associated with the receiving party to generate a cover message. For example, the contextual information can be e.g., the weather, a favorite sports team, or family associated with the receiving party. Only the receiving party viewing the benign, contextually appropriate message (e.g., with the personal contextual information) will realize that there is actually a transaction being offered, occurring, and/or being completed. The entire transaction can be completed without any third-party realizing that the transaction has occurred. This represents an improvement over existing systems in terms of network security and privacy security.

The receipt for purchasing the product can be unsecured, or encrypted and secured. The buyer may also receive a cover message that indicates the receipt is available without revealing the availability or existence of the receipt. The buyer can go to a predetermined Internet address to view the receipt. Some embodiments may also include secure refunds of purchased products with any or all of the security measures discussed herein. Furthermore, the seller may also receive a cover message that, without revealing the existence of the purchase transaction, indicates the buyer has completed the purchase transaction.

Sending Message and/or Content

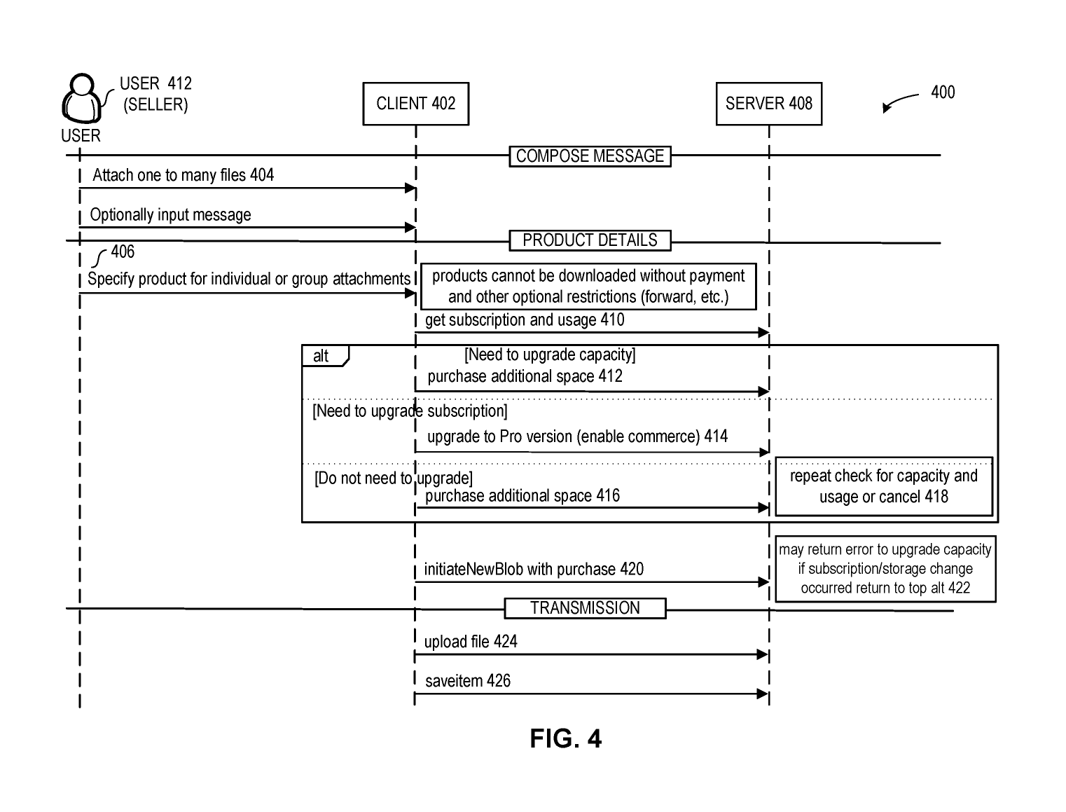

FIG. 4 presents a flowchart 400 illustrating an exemplary method for sending a message and/or product content to a recipient in a purchase transaction in accordance with an embodiment. FIG. 4 provides detail for an embodiment based on the second flow depicted in FIG. 2. Note that different embodiments may vary according to detail and order of operations, and embodiments are not limited to the specific operations depicted in the figure. During operation, a sending device (e.g., client 402) can initially receive content with a message as inputted by a user. The user may be selling a product to others. The user selling the product may attach one to many files and optionally input a message (operation 404). The system may receive content uploaded by the user or selected by the user. The system can receive rules and permissions from the user for the message and/or content. The system can also use default rules and permissions for the message and/or content.

The client may receive input from a user specifying a product for individual or group attachments (operation 406). The product content may be previously uploaded to a server 108 or attached with the message. The user may specify that certain content indicated as products may not be downloaded without payment. The system may also by default disallow the download of products without payment.

In some embodiments, the system may determine whether the user is associated with a subscription service (operation 410). The user may initially sign up to be a member/subscriber. This allows the user to upload content to the server up to a maximum storage capacity limit for the user. The system may determine the current storage usage for the user's account. If the user's account has reached a maximum allowed storage capacity, the user may purchase additional space on the server for hosting content (operation 412). The user may also upgrade his account to a professional account, which enables commerce capabilities (operation 414). The system may receive a user request to upgrade to allow transferring the content or other objects stored at a server to one or more receiving devices. The transfer of the content may occur after a purchasing party submits payment for the content. If the user does not need to upgrade, the user may still choose to purchase additional space (operation 416). The system may perform a repeat check for capacity and usage to ensure that there is sufficient storage space or cancel the message/storage upload (operation 418).

The system may perform an operation initiateNewBlob with purchase (operation 420). The system may initiate a conversation and generate a new data structure framework in device memory and/or storage for the conversation, and prepare (e.g., allocate and initialize) device memory and/or storage for holding content to be transferred (e.g., a binary object such as image file, Word document, or any other content) associated with the conversation. The system may store data indicating the association between the conversation and the content to be transferred, and may generate a reference to the content to provide to any purchasing parties. In some embodiments, the system may initialize a conversation in response to receiving payment from a purchasing party and/or prior to transferring content.

The system may return error to upgrade capacity if a subscription and/or storage change occurred and continue with operation 412 (operation 422). For example, if the user attempts to send two gigabytes and only one gigabyte is available, then the system may direct the user to upgrade capacity.

The system (e.g., client 402) may then upload the message and content to server 408 (operation 424) and save the content locally (operation 426). In some embodiments, the system may automatically detect whether the user actually receives the encrypted content and only charge the user when the user actually receives the content.

### Encryption and Rules

The sending device can encrypt the message and/or content, which may include rules, permissions, a security object that includes permission and rule data, a unique identifier, and/or any other data. The sending device can encrypt data using a symmetric key, and then encrypt the symmetric key separately for each intended recipient using a recipient-specific public key. The sending device may send the encrypted symmetric keys to multiple devices. The recipients of the encrypted symmetric keys can use their own private key to decrypt and extract the symmetric key, and use the symmetric key to decrypt data sent from the sending device.

Generally, the system may encrypt all objects using a per-object symmetric encryption key, and the system encrypts the key for a symmetric key-encrypted object using asymmetric encryption. That is, the sending device need only encrypt an object once using a symmetric key and then encrypt the symmetric key specifically for each recipient. The sending device need not encrypt an object multiple times for different recipients. This saves time and is more efficient because some of the objects may be large file attachments or content (e.g., 1 terabyte or larger).

The system may use a different symmetric key for encrypting each object and not reuse a symmetric key to encrypt a different object. For example, the system may use a different symmetric key for encrypting each of the message, the message attachment, a thumbnail attachment, and all other objects associated with the message. Thus, even if a malicious party may attack and compromise one symmetric key (e.g., for an attachment), the other symmetric keys remain intact (e.g., for other objects associated with the message).

The system can generate a universally unique identifier for identifying data or portions of the data. For example, the system (e.g., sending device) may split a large file into two portions and generate a unique identifier for the larger portion. The system may send the unique identifier to a receiving device and the server. The unique identifier functions as a key to a distributed hash table. This distributed hash table can be implemented over multiple servers. The distributed hash table stores the association between stored data and the unique identifier. The receiving device can send a query with the unique identifier to any server that implements the distributed hash table and/or stores a copy of the data (e.g., to retrieve the larger portion of data). Note that the unique identifier is optionally stored via a distributed lookup table including but not limited to a distributed hash table. The receiving device can retrieve the data from any number of servers since the data may be replicated and stored on multiple servers.

The sending device can send a large encrypted (or unencrypted) portion of the message and/or content of a predetermined size to an enterprise server or a server in the cloud for storage. For example, if the message includes a large file attachment, the sending device can encrypt the large file attachment, and split the file (encrypted or unencrypted) into two portions (e.g., the first 100 bytes of the file for small portion and the remainder of the file for the large portion). The sending device can then send the bigger portion of the file attachment to a server that the receiving device can retrieve from. Note that the system may provide the receiving device the bigger portion of the file attachment since a distributed hash table stores associations between the stored bigger portion of the file attachment with a unique identifier. The system may retain the small portion of the data and store it locally within a secure storage of the system, and, in some embodiments, can also include a copy of the small portion when sending a message. Without the small portion of the data, the receiving device (and malicious attackers) may not be able to put together the complete set of data. In some embodiments, the sending device can split the encrypted file (or an unencrypted file) into multiple portions that include more than two portions, and the portions can vary in size. For example, there can be many small pieces, one large and one small, one large and several small, etc. Furthermore, the server may also send the entire encrypted large file attachment or content to a server.

The system may send a large portion of the encrypted (or unencrypted) file to a server that is one of many enterprise hardware devices within an enterprise computing environment, or the server can be part of the messaging and computing system. In some embodiments, the system may also access a server of a cloud service (e.g., Dropbox or Google cloud storage) on the Internet to send and store data.

The sending device may send the message and/or content, which may include rules, permissions, the unique identifier, the security object, the small portion of the encrypted (or unencrypted) file (or a link to the small portion), and/or any other data to the server. In some embodiments, the sending device may send contact information, passwords, lists, and draft messages to other users, encrypted or unencrypted, and may revoke the information at a later time or based on a condition set by the user of the sending device.

The sending device user can set rules that control message and special content after they have been received by the receiving device. For example, the user can set rules for when the system will delete the message. For example, the system (e.g., a receiving device) may delete the message after a receiving party first views the message according to a rule. Also, the user can set a rule so that the system will delete the message after the receiving device takes a screenshot of the message. The user can also set a rule so that the sending party is notified of any screenshots taken by receiving parties. The system may also allow the user to select whether the rules apply to all recipients or a selection of recipients.

If the sending device receives a user command to perform an operation on the message and/or content, the sending device may send the command to the receiving device to execute the command. In some embodiments, the receiving device can also forward the command to other devices that have been forwarded the message.

In some implementations, the sending device may receive data from a computing device indicating they received a copy of the forwarded message. The sending device may directly send the command to any device that has received a copy of the forwarded message. Devices that receive the command may then comply with the command.

### Change Permissions on Recipients of New Message

The user can set permissions to allow other users to forward the message, and can set permissions to allow other users to stash (e.g., archive or move to a folder for storage and/or classification) the message.

A stash is also a location synchronized across all user devices for message drafts, uploaded files, notes, passwords, objects etc. that may be then sent or shared via the platform. The stash may function as a virtual hard drive. Stash allows the user to save versioned objects of all types to the distributed system for later viewing, sharing, collaboration and group editing, and sending. A user can put his items in stash to have it appear on all of the user's other devices. Everything stored with stash may be encrypted. Only the user and the people that the user specifies may view/edit, etc. and have the power to roll back to old versions, view thumbnails (e.g., similar to the attachment view), and search/sort in a manner similar to messages and attachments. Some examples of stash features include but are not limited to message drafts, files, and notes.

Message drafts—these are messages a user started to compose and wishes to resume editing on a different device or pass off to a different user to edit. The message draft may or may not be encrypted, and the sender and any shared viewers/editors may be given various levels of permissions to access the message draft. Multiple versions can be saved and rolled back, and the user can view the differences between versions, etc. Some embodiments can also support files that have been uploaded to the system and attached but not sent.

Files—this is a very safe and secure file hosting service. A user can upload one-to-many files and folders, assign permissions on who can view/access/edit, assign tags to classify a file, and set reminders to perform some action on the file. Some embodiments may also support all versioning features, roll back viewable differences, etc.

Notes—includes, but is not limited to, free form text, pictures, video, Global Positioning System (GPS) location, maps, voice, etc. with note-taking capability. Users can tag, attach files, assign permissions, set reminders, and use versioning capability.

The user can also allow other users to add and remove participants. Note that the user can also change permissions for a single recipient or any set of recipients. Other examples of permissions include but are not limited to printing, selecting text, and external downloading.

Receiving Message and/or Content

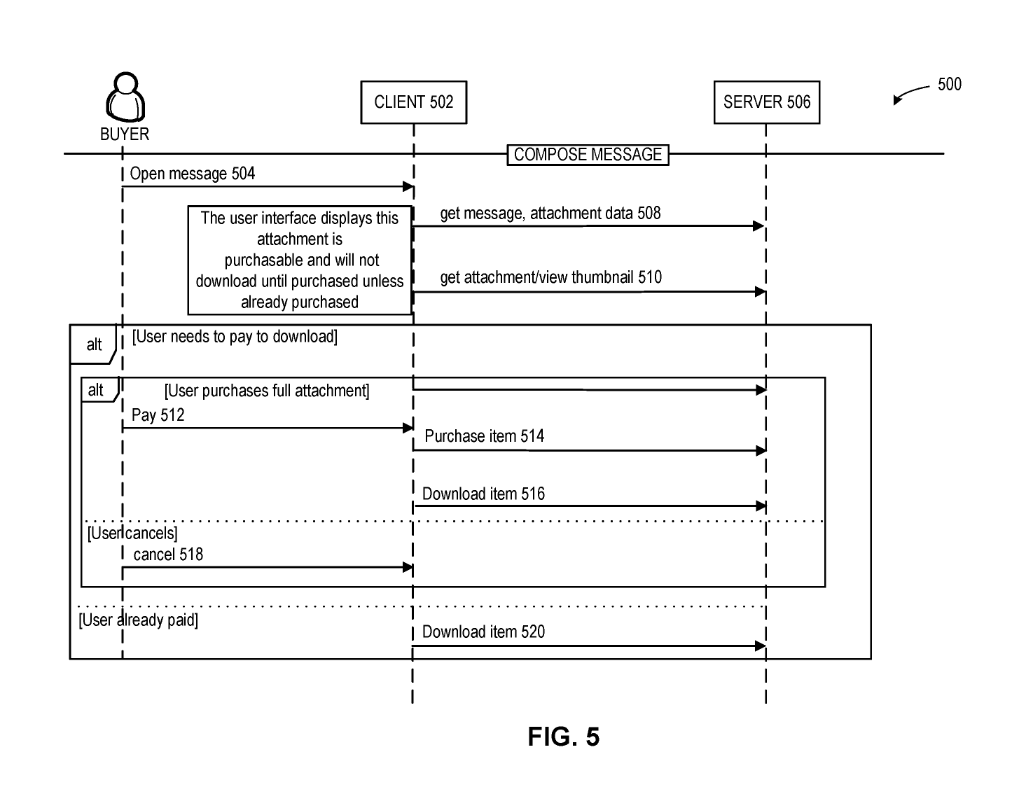

FIG. 5 presents a flowchart illustrating an exemplary method for a purchasing party to purchase and obtain content in accordance with an embodiment. Note that different embodiments may vary according to order of operations, and embodiments are not limited to the specific operations depicted in the figure.

A receiving device (e.g., client 502) may initially receive input from a user to open a message (operation 504). The receiving device may connect to a server 506 to retrieve the message and attachment data (operation 508). The receiving device may then retrieve the attachment and thumbnail information and display the thumbnails (operation 510). The user interface on client 502 may display information indicating that the attachment is purchasable and will not download until purchased (unless already purchased).

In some cases, the user may need to pay to download the attachment data. Client 502 may receive payment from the user (operation 512), and send the purchase transaction information to server 506 (operation 514). Client 502 may then download the item (operation 516). Client 502 may also receive user input to cancel the purchase (operation 518). If the user has previously paid for the item, then the system may also download the item (operation 520).

Client 502 may receive the message and/or attachment content from a device that originally sent the message and/or content, or from a device that forwarded the message and/or content. The receiving device may receive the message via a messaging server. The message and/or content may be encrypted (or unencrypted) and the receiving device may decrypt and/or extract various data from the message and/or content received. This data may include one or more of rules, permissions, a universally unique identifier, a link to a substantial portion of an encrypted (or unencrypted) large file attachment or content stored on a remote server, a small portion of the encrypted (or unencrypted) large file attachment or content (e.g., a small .zip file), a security object, and/or any other data included with the message. In some embodiments, the receiving device may receive a link to a small portion of a large file attachment or other content, and query a server for the small portion rather than receive the small portion with the message.

The receiving device may obtain additional data from a server if the message and/or content indicates that a portion of a large encrypted (or unencrypted) file is stored elsewhere. For example, if the message includes a large file attachment, then the receiving device may retrieve a large encrypted (or unencrypted) portion of the file attachment from a remote server. The receiving device sends the unique identifier to one or more servers over the network and then receives the corresponding data back from a server. The receiving device can retrieve the stored data (e.g., large file attachment or other content) from any one of multiple servers that replicate the additional data. The receiving device may then combine together the split portions of the large file attachment or content. If the receiving device can successfully decrypt an entire encrypted file, then the receiving device has obtained the correct data. For example, if the portions are encrypted, then the full encrypted file is a combination of an encrypted piece and an encrypted remainder. The full encrypted file can then be decrypted using the symmetric key whereas the encrypted piece or encrypted remainder would fail to decrypt independent of each other. The big portion (e.g., remainder file) may be publicly available on Dropbox, a web server, etc. A diff file (e.g., a much smaller portion) may be securely transmitted or stored somewhere. The receiving device may apply the diff file to the remainder file to generate a file equal to the original file (encrypted or not). Note that in some scenarios, a device may combine together portions of an unencrypted file.

Note that multiple servers may implement a distributed hash table storing associations between the universally unique identifier and objects such as file attachments or content. The unique identifier may function as a lookup key for the distributed hash table. The servers can look up the distributed hash table to identify the correct object to return to a device that submits a query using a corresponding unique identifier.

The distributed hash table may also store public keys for users or receiving devices, so that a sending device can request a public key for any potential recipient. The sending device can obtain public keys for multiple recipients, and may send each recipient the same symmetric key but the symmetric key is encrypted using each recipient's specific public key. Each recipient can decrypt and extract the symmetric key using their own specific private key.

Since the stored data is replicated and distributed on different servers, there are multiple ways in which the receiving device can obtain the stored data. In some embodiments, the receiving device can attempt to retrieve the stored data by sending a query with the unique identifier key to a local hardware device or an enterprise computing device. The local hardware device may return the data or may provide the receiving device with information on servers that store the data and their respective download speeds, including which servers provide fastest download speed. The receiving device can attempt to retrieve the stored data by submitting a query to servers with access to the distributed hash table and/or stored copies of the data, and receiving data from a server that is known to be trusted. The receiving device can also retrieve data by sending the query with the unique identifier key to a server that is part of the messaging and communication system (e.g., the software as a service). In some cases it may be faster for the receiving device to access an enterprise hardware device to retrieve data over a local area network but if the receiving device does not have access to the enterprise hardware device, then the receiving device can access the data from the software as a service.

The receiving device may display the message or otherwise make the content available to the user of the receiving device. If the receiving device receives user input indicating an operation on the message and/or content, the receiving device may determine whether the operation is authorized based on the rules and permissions. If the operation is authorized, then the receiving device may execute the operation on the message and/or content. The receiving device continues to manage the message and/or content while complying with the rules and permissions. For example, the receiving device may determine when to delete an object based on a rule associated with the object. As another example, the receiving device may receive subsequent requests to perform operations on the message and/or content and the receiving device may only perform such operations when authorized by the permissions and rules.

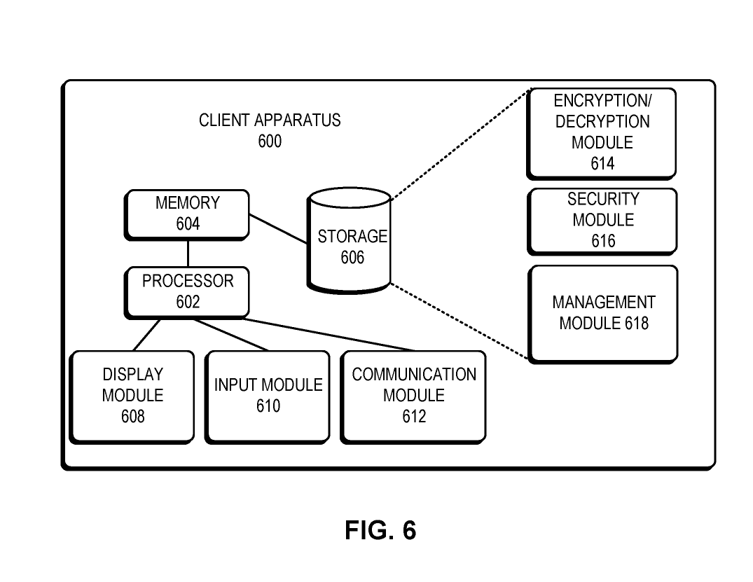

FIG. 6 illustrates an exemplary client apparatus that facilitates a messaging and content sharing platform with conversational commerce in accordance with an embodiment. In this example, a client apparatus 600 for messaging and content sharing can include but is not limited to a processor 602, a memory device 604, and a storage device 606. Apparatus 600 may include a display module 608, an input module 610, and a communication module 612. In some embodiments, apparatus 600 may be implemented on a mobile device.

Storage device 606 can store instructions which when loaded into memory 604 and executed by processor 602 cause processor 602 to perform the aforementioned operations (e.g., for a sending device or a receiving device). More specifically, the instructions stored in storage device 606 can include an encryption/decryption module 614, a security module 616, and a management module 618.

Encryption/decryption module 614 encrypts and decrypts objects such as messages, attachments, and other content objects. Security module 616 manages the rules and permissions associated with objects. Management module 618 may perform operations of the client described with respect to the figures. For example, management module 618 may obtain subscription and usage data from the server for a selling user. Management module 618 also obtain message and attachment data, and/or obtain thumbnail data and download information from a server for a purchasing user.

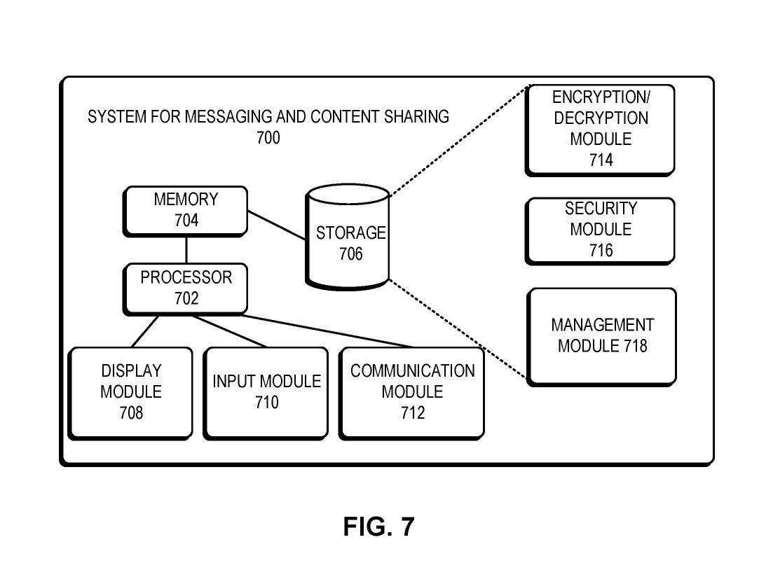

FIG. 7 illustrates an exemplary computer system that facilitates a messaging and content sharing platform with conversational commerce in accordance with an embodiment. In this example, a system 700 for messaging and content sharing can include but is not limited to a processor 702, a memory device 704, and a storage device 706. System 700 may optionally include a display module 708, an input module 710, and a communication module 712. In some embodiments, system 700 may be implemented as a server.

Storage device 706 can store instructions which when loaded into memory 704 and executed by processor 702 cause processor 702 to perform the aforementioned operations (e.g., for a sending device or a receiving device). More specifically, the instructions stored in storage device 706 can include an encryption/decryption module 714, a security module 716, and a management module 718.

Encryption/decryption module 714 encrypts and decrypts objects such as messages, attachments, and other content objects. Security module 716 manages the rules and permissions associated with objects. Management module 718 may perform the operations of one or more servers described with respect to the figures. For example, management module 718 may maintain subscription and storage usage data and perform checks for capacity and usage for a user and determine whether the user's storage usage has exceeded the storage capacity.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for transferring an object comprising:
receiving the object from a sending device operated by a user, wherein the object is a message or other content;
receiving data indicating one or more restrictions set by the user associated with the object;
receiving a request from a receiving device to obtain the object;
determining that one or more restrictions associated with the request to obtain the object are satisfied; and
sending a portion of the object to the receiving device.

2. The method of claim 1, further comprising:
receiving user communication indicating that an attachment or a file located on a server is a product;
determining a subscription and current storage usage associated with an account associated with the user;
determining that the account lacks sufficient storage capacity to store the product;
informing the user that account lacks sufficient storage capacity to store the product; and
receiving a user request to increase the storage capacity.

3. The method of claim 2, further comprising:
receiving a user request to upgrade to allow transferring the object or other objects stored at a server to one or more receiving devices.

4. The method of claim 2, further comprising:
initiating a conversation and generating a new data structure framework in at least one of device memory and storage for the conversation; and
allocating and initializing at least one of the device memory and storage to hold content to be transferred.

5. The method of claim 1, further comprising:
receiving at least one of data indicating user input from a second user scanning a Quick Response (QR) code of an item, data indicating the second user taking a picture of a the item, and data indicating the second user sending a message to a merchant's account that the second user would like to purchase the item;
providing to the second user at least a product token;
receiving a payment token and a shipping label from the second user;
providing the second user with a cryptographically secure receipt indicating a purchase of the item; and
receiving data indicating that the item has been sent to the second user.

6. The method of claim 1, further comprising:
receiving data from the sending device indicating that the receiving device may display a thumbnail preview but may not download a full version or unlock the full version until payment is received.

7. The method of claim 1, wherein a rule is one of:
disallowing the receiving device from taking a screenshot of the object;
disallowing the receiving device from printing the object;
disallowing the receiving device from downloading the object;
requiring that the receiving device delete an object after taking a screenshot; and
requiring that the receiving device delete an object after the user views the object.

8. The method of claim 1, further comprising:
receiving a request from a second device, wherein the second device has been forwarded the message and/or content;
receiving a request to download a full version or unlock the full version from the second device;
determining that the second device has been forwarded the message and/or content from the recipient device; and
fulfilling the request to download the full version or unlock the full version from the second device.

9. The method of claim 1, further comprising:
receiving data indicating that a particular user sends at least one of money, content, and communication to an email address or Short Message Service (SMS) number; and
completing a transaction when another party to the transaction signs up to receive the at least one of money, content, and communication.

10. The method of claim 1, wherein a permission indicates whether the receiving device is allowed to perform one of the following:
stash the message and/or content;
remove a participant from the message header indicating parties that receive the message and associated replies;
take a screenshot that includes the message and/or content
select text from the message and/or content;
print the message and/or content; and
download the message and/or content to external storage.

11. The method of claim 1, wherein the object is encrypted with a symmetric key and the symmetric key is encrypted with a public key of the receiving device; and wherein sending the portion of the object further comprises:
encrypting the object and sending a portion of the encrypted object to the receiving device.

12. The method of claim 1, wherein the one or more restrictions include the content may not be downloaded without payment.

13. The method of claim 1, further comprising:
dividing a content file into at least two portions;
sending at least one portion of the content file to a server that does not store the other portion;
receiving a query from the receiving device with a unique identifier associated with the one portion of the content file; and
providing the content file to the receiving device.

14. The method of claim 1, wherein receiving a request from a receiving device to obtain the object further comprises receiving a request from the receiving device for message and/or attachment data; and
wherein determining that one or more restrictions associated with the request to obtain the object are satisfied further comprises determining that a purchase price associated with the object has been paid.

15. A system comprising:
a processor;
a memory; and
a non-transitory computer-readable storage medium storing instructions that when executed by a computer cause the computer to perform a method for sending an object, the method comprising:
receiving the object, wherein the object is a message or other content;
receiving user input to set permissions and/or rules for the object, wherein a respective permission indicates a respective operation that a receiving device may perform on the object, and wherein a respective rule indicates an operation that the receiving device performs when a specified condition occurs in connection with the object;
attaching the permissions and rules to the object;
sending a portion of the object to the receiving device.
receiving the object from a sending device operated by a user, wherein the object is a message or other content;
receiving data indicating one or more restrictions set by the user associated with the object;
receiving a request from a receiving device to obtain the object;
determining that one or more restrictions associated with the request to obtain the object are satisfied; and
sending a portion of the object to the receiving device.

16. The system of claim 15, wherein the method further comprises:
receiving user communication indicating that an attachment or a file located on a server is a product;
determining a subscription and current storage usage associated with an account associated with the user;
determining that the account lacks sufficient storage capacity to store the product;
informing the user that account lacks sufficient storage capacity to store the product; and
receiving a user request to increase the storage capacity.

17. The system of claim 15, wherein the method further comprises:
receiving a user request to upgrade to allow transferring the object or other objects stored at a server to one or more receiving devices.

18. The system of claim 15, wherein the method further comprises:
initiating a conversation and generating a new data structure framework in at least one of device memory and storage for the conversation; and
allocating and initializing at least one of the device memory and storage to hold content to be transferred.

19. The system of claim 15, wherein the method further comprises:
receiving at least one of data indicating user input from a second user scanning a Quick Response (QR) code of an item, data indicating the second user taking a picture of a the item, and data indicating the second user sending a message to a merchant's account that the second user would like to purchase the item;
providing to the second user at least a product token;
receiving a payment token and a shipping label from the second user;
providing the second user with a cryptographically secure receipt indicating a purchase of the item; and
receiving data indicating that the item has been sent to the second user.

20. A non-transitory computer-readable storage medium storing instructions that when executed by a computer cause the computer to perform a method for transferring an object, the method comprising:
receiving the object, wherein the object is a message or other content;
receiving the object from a sending device operated by a user, wherein the object is a message or other content;
receiving data indicating one or more restrictions set by the user associated with the object;
receiving a request from a receiving device to obtain the object;
determining that one or more restrictions associated with the request to obtain the object are satisfied; and
sending a portion of the object to the receiving device.

21. The storage medium of claim 20, wherein the method further comprises:
receiving data from the sending device indicating that the receiving device may display a thumbnail preview but may not download a full version or unlock the full version until payment is received.

22. The storage medium of claim 20, wherein the method further comprises:
receiving data indicating that a particular user sends at least one of money, content, and communication to an email address or Short Message Service (SMS) number; and
completing a transaction when another party to the transaction signs up to receive the at least one of money, content, and communication.

23. The storage medium of claim 20, wherein a permission indicates whether the receiving device is allowed to perform one of the following:
stash the message and/or content;
remove a participant from the message header indicating parties that receive the message and associated replies;
take a screenshot that includes the message and/or content
select text from the message and/or content;
print the message and/or content; and
download the message and/or content to external storage

24. The storage medium of claim 20, wherein the method further comprises:
wherein the object is encrypted with a symmetric key and the symmetric key is encrypted with a public key of the receiving device; and wherein sending the portion of the object further comprises:
encrypting the object and sending a portion of the encrypted object to the receiving device.

25. The storage medium of claim 20, further comprising:
dividing a content file into at least two portions;
sending at least one portion of the content file to a server that does not store the other portion;
receiving a query from the receiving device with a unique identifier associated with the one portion of the content file; and
providing the content file to the receiving device.
